(19) United States
(12) Patent Application Publication
(10) Pub. No.: US 2006/0072248 A1
(43) Pub. Date: Apr. 6, 2006

(54) Electro-dynamic exciter

(75) Inventors: Shigehisa Watanabe, Fujiyoshida-shi (JP); Yoshizumi Ohta, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd.

(21) Appl. No.: 11/230,111

(22) Filed: Sep. 19, 2005

(30) Foreign Application Priority Data
Sep. 22, 2004 (JP) JP2004-276243
Oct. 19, 2004 (JP) JP2004-303947
Dec. 1, 2004 (JP) JP2004-347958
Dec. 1, 2004 (JP) JP2004-347959
Dec. 9, 2004 (JP) JP2004-356104

(51) Int. Cl. H04R 25/00; G11B 5/33

(52) U.S. Cl. 360/318; 381/150

(57) ABSTRACT

An electro-dynamic exciter includes a magnetic circuit assembly composed of an outer yoke having a cylindrical peripheral wall, and a bottom wall connected to one end of the peripheral wall, a flat magnet located within the outer yoke and placed on the bottom wall of the outer yoke, and a flat inner yoke placed on the magnet. A magnet gap is defined between the outer yoke and the inner yoke. The magnetic circuit assembly is vibrationally supported on a support panel by means of a flexible carrier. The support panel is located in a face-to-face relation to the other end of the peripheral wall of the outer yoke. The flexible carrier is made from a flexible sheet material. The flexible carrier includes an annular anchor section secured to the support panel, a cylindrical section connected to the anchor section and coaxially extending into the magnetic gap, a flexible section extending radially inwardly from the anchor section toward the inner yoke and secured to the inner yoke. The magnetic coil is wound around the cylindrical section.

This application claims priority under 35 U.S.C. § 119 to Japanese Patent Application No. 2004-276243 filed Sep. 22, 2004; 2004-303947 filed Oct. 19, 2004; 2004-347958 and 2004-347959 both filed Dec. 1, 2004; and 2004-356104 filed Dec. 9, 2004, the entire contents of which are hereby incorporated by reference.

### BACKGROUND OF THE INVENTION

1. Field of the Invention

The present invention relates to electro-dynamic exciters assembled into a cellular phone or other mobile communication equipments and designed to vibrate a panel so as to make the phone ring when signals are received from another phone and also, reproduce sounds.

Conventionally, a speaker is incorporated into a personal computer, a cellular phone and other electronic devices to provide various acoustic outputs. As such electronic devices become smaller and smaller, there is also a need to reduce the size of the speaker as well as to facilitate assembly of the speaker. To meet this need, there has been proposed a panel speaker as disclosed in Japanese patent application publication No. 2003-143690.

Referring specifically to FIG. 5, the panel speaker includes an electro-dynamic exciter 20 for vibrating a vibratory panel V. The exciter includes an outer yoke 21, a flat magnet 22 placed on and located within the outer yoke 21, and an inner yoke 23 placed on the magnet 22 and located within the outer yoke 21. The outer yoke 21, the magnet 22 and the inner yoke 23 collectively form a magnetic circuit assembly 24. A magnetic gap is defined between the cylindrical wall of the outer yoke 21 and the outer peripheral surface of the inner yoke 23 to receive a magnetic coil 25. The magnetic coil 25 is wound on a cylindrical member 26 made, for example, of resin or paper. The cylindrical member 26 with the magnetic coil 25 wound thereon is secured to a support panel 27 which is, in turn, secured to the vibratory plate V. The magnetic circuit assembly 24 and the support panel 27 are connected by a flexible carrier 28 in the form of a thin metal plate. The flexible carrier 28 has an annular shape. The inner periphery of the flexible carrier 28 is secured to the outer peripheral surface of the outer yoke 21 of the magnetic circuit assembly 24. The outer periphery of the flexible carrier 28 is secured to a post 29 by means of fasteners 30. The post 29 extends from the support panel 27.

The exciter 20 is adhered to the vibratory plate V by means of a double-sided adhesive tape or the like. The vibratory plate V is, for example, an acrylic plate placed on a liquid crystal display used in a cell phone or other electronic devices.

Various steps need to be taken before the magnetic coil is positioned within the magnetic gap. First, the cylindrical member is made of resin or paper. The magnetic coil is then wound on the cylindrical member. The cylindrical member is thereafter secured to the support panel. The conventional exciter is thus costly and requires a substantial amount of time to assemble all of those parts.

It is, therefore, an object of the present invention to provide an electro-dynamic exciter which can reduce the cost of manufacture and provide a high level of productivity by eliminating the use of a discrete cylindrical member and instead, winding a magnetic coil around a flexible carrier through which a magnetic circuit assembly is connected to a support panel, and which is simple in structure, maintains a high level of quality, and is highly reliable in operation.

2. Advantages of the Invention

According to the present invention, the electro-dynamic exciter does not require the use of a discrete cylindrical member to mount a magnetic coil, as opposed to the convention exciter. This brings about a reduction in the number of parts, the number of assembling steps, and the cost of manufacture. Also, the electro-dynamic exciter, due to its structural simplicity, can maintain its high quality, is reliable in operation and is economical to manufacture.

### SUMMARY OF THE INVENTION

According to the present invention, there is provided an electro-dynamic exciter comprising a magnetic circuit assembly including an outer yoke having a bottom wall and a cylindrical peripheral wall extending from a peripheral edge of the bottom wall and terminating at a top peripheral edge, a flat magnet placed on the bottom wall of the outer yoke and located within the outer yoke, a flat inner yoke placed on the magnet and having an outer peripheral surface, and an annular magnetic gap defined between the cylindrical peripheral wall of the outer yoke and the outer peripheral surface of the inner yoke, a support panel mounted in a face-to-face relation to the outer yoke and axially spaced from the top peripheral edge of the outer yoke, a flexible carrier for supporting the magnetic circuit assembly on the support panel so that the magnetic circuit assembly is axially vibrated, the flexible carrier including an annular anchor section secured to the support panel, a flexible section extending radially inwardly from the anchor section toward one side of the inner yoke located adjacent to the support panel, a joint section extending radially inwardly from the flexible section and joined to the magnetic circuit assembly, and a cylindrical section connected to the anchor section and coaxially extending into the magnetic gap, and a magnetic coil wound around the outer peripheral surface of the cylindrical section.

In this exciter, the magnetic coil is wound around the cylindrical section as part of the flexible carrier. This arrangement eliminates the use of a separate cylindrical member as used in the conventional exciter. Additionally, the flexible carrier supports the magnetic circuit assembly within the outer yoke. This arrangement brings about a reduction in the size of the electro-dynamic exciter.

In a preferred embodiment, the cylindrical section of the flexible carrier has an end radially outwardly bent and engaged with the magnetic coil. This engagement holds the magnetic coil against axial displacement. The annular anchor section, the flexible section, the joint section and the cylindrical section of the flexible carrier are integrally formed from a flexible sheet material.

In another preferred embodiment, the joint section of the flexible carrier includes at least one through opening. The opening axially extends through the joint section.

More specifically, the flexible section is annular in shape and has an inner peripheral edge. The joint section has a cylindrical portion axially extending from the inner peripheral edge of the flexible section toward the inner yoke and having a distal edge positioned adjacent to the inner yoke, and an adhering portion extending radially inwardly from the distal edge of the cylindrical portion and adhesively attached to the inner yoke. The through opening is located in the adhering portion. Advantageously, the adhesive is held within the joint section after the adhesive is applied between the support panel and the inner yoke and the adhering portion. This insures firm connection between the flexible carrier and the inner yoke.

In another preferred embodiment, the flexible section is annular in shape and has an inner peripheral edge. The joint section has a cylindrical portion axially extending from the inner peripheral edge of the flexible section toward the inner yoke and having a distal edge positioned adjacent to the inner yoke, an adhering portion extending radially inwardly from the distal edge of the cylindrical portion and adhesively attached to the inner yoke, and at least one through opening axially extending through the adhering portion. The inner yoke is formed at its one side with a recess sized to receive the adhering portion so that the adhering portion is adhered to the inner yoke. The recess also serves to properly position the flexible carrier relative to the inner yoke.

In an alternative embodiment, the inner yoke has a through hole axially extending therethrough and sized to receive the joint section so that the joint section is adhered to the magnet. This arrangement enables the flexible carrier to be more reliably adhered to the magnetic circuit assembly and insures proper positioning of the flexible carrier relative to the magnetic circuit assembly.

In a preferred embodiment, the support panel has a retainer coaxial with the magnetic gap and extending toward the magnetic circuit assembly. The cylindrical section of the flexible carrier has an outer peripheral surface, and the retainer has an inner peripheral surface connected to the outer peripheral surface of the cylindrical section of the flexible carrier. The magnetic coil is located downwardly from the lower end of the retainer and wound around the outer peripheral surface of the cylindrical section of the flexible carrier which extends into the magnetic gap. With this arrangement, the flexible carrier can more firmly and readily be secured to the support panel.

In a preferred embodiment, a terminal wiring pattern is located outwardly of the retainer of the support panel and the peripheral wall of the outer yoke. The magnetic coil has a coil wire with a terminal end electrically connected to the terminal wiring pattern. It is to be understood that the terminal wiring pattern is subject to substantial vibrations at its resonant point. If occurs, the wire coil could be disconnected from the terminal wiring pattern. Such a risk can be substantially reduced by mounting the terminal wiring pattern to the support panel.

Preferably, a part of the coil wire which extends from the magnetic coil to the terminal wiring pattern is arranged along the support panel and covered by a resinous protective coating. Also, the peripheral wall of the outer yoke preferably has a cutout axially aligned with the protective coating so that the protective coating is kept out of contact with the peripheral wall of the outer yoke. This configuration enables the outer yoke and thus, the entire exciter to have a low profile in its axial direction.

In a preferred embodiment, the support panel includes a plurality of locking protrusions projecting from the inner peripheral surface of the retainer. The flexible carrier includes a plurality of corresponding apertures defined in the outer peripheral surface of the cylindrical section. The locking protrusions are lockingly engaged with the respective apertures so that the flexible carrier is secured to the support panel. This arrangement insures easy and firm mounting of the flexible carrier to the support panel.

### BRIEF DESCRIPTION OF THE DRAWINGS

FIG. 1 is a plan view of an electro-dynamic exciter according to a first embodiment of the present invention;

FIG. 2 is a sectional view taken on the line II-II in FIG. 1;

FIG. 3 is a sectional view taken on the line III-III in FIG. 1;

FIG. 4 shows the manner in which a magnetic coil is wound on a flexible carrier, with the encircled part of the magnet coil and the flexible carrier being separately shown on an enlarged scale;

FIG. 5 is a side view, partly sectioned, of a conventional panel speaker;

FIG. 6 is a plan view of an electro-dynamic exciter according to a second embodiment of the present invention;

FIG. 7 is a sectional view taken on the line VII-VII in FIG. 6;

FIG. 8 is a sectional view taken on the line VIII-VIII in FIG. 6;

FIG. 9 is a plan view of an electro-dynamic exciter according to a third embodiment of the present invention;

FIG. 10 is a sectional view taken on the line X-X in FIG. 9;

FIG. 11 is a bottom view of the electro-dynamic exciter shown in FIG. 9;

FIG. 12 is a sectional view taken on the line XII-XII in FIG. 9;

FIG. 13 is a vertical sectional view of an electro-dynamic exciter according to a fourth embodiment of the present invention;

FIG. 14 is a perspective view of an outer yoke used in the electro-dynamic exciter shown in FIG. 13;

FIG. 15 is a plan view of an electro-dynamic exciter according to a fifth embodiment of the present invention;

FIG. 16 is a sectional view taken on the line XVI-XVI in FIG. 15;

FIG. 17 is a sectional view taken on the line XVII-XVII in FIG. 15; and

FIG. 18 is an exploded view of the primary components of the electro-dynamic exciter shown in FIG. 15.

### DETAILED DESCRIPTION OF THE DRAWINGS AND THE PRESENTLY PREFERRED EMBODIMENTS

The present invention will now be described with reference to the accompanying drawings.

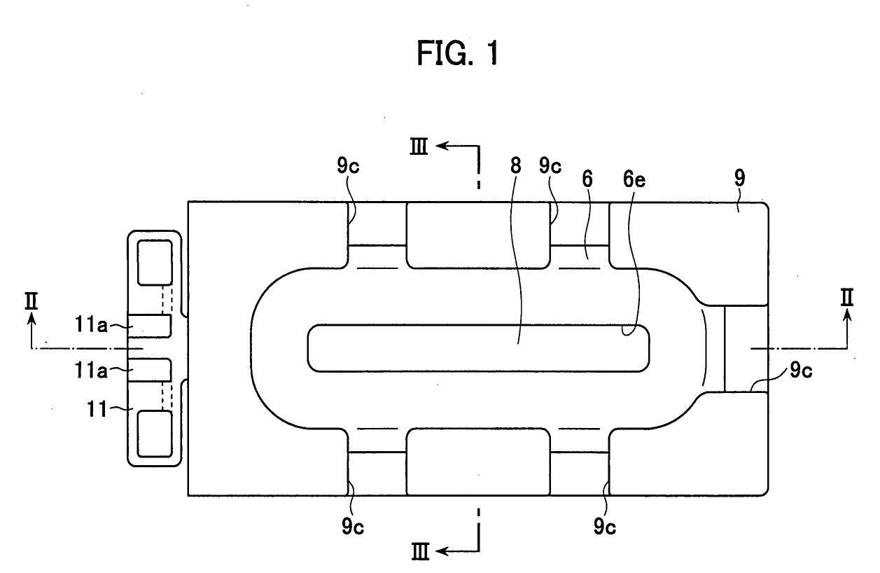

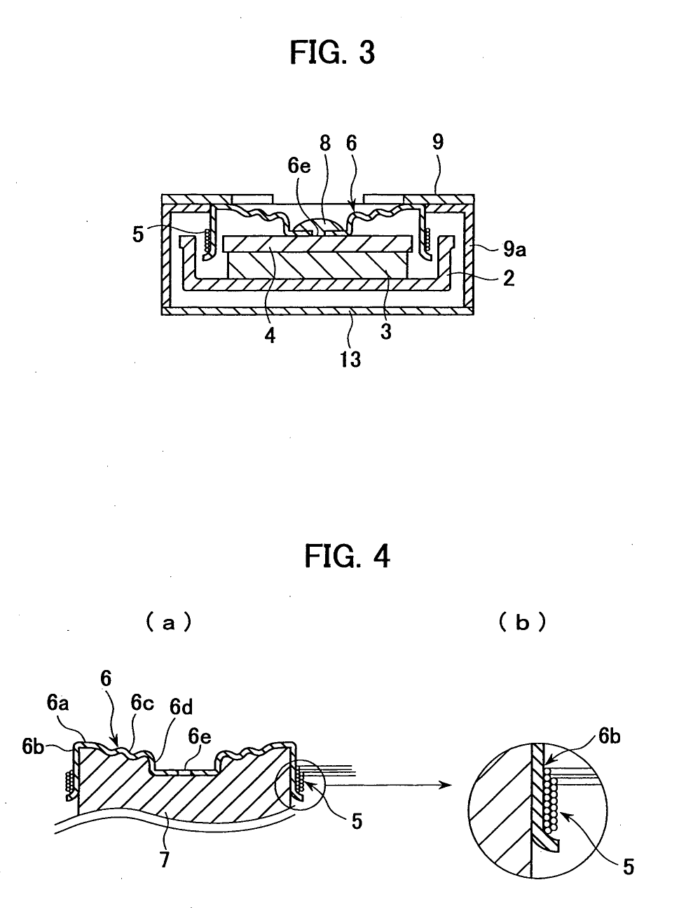

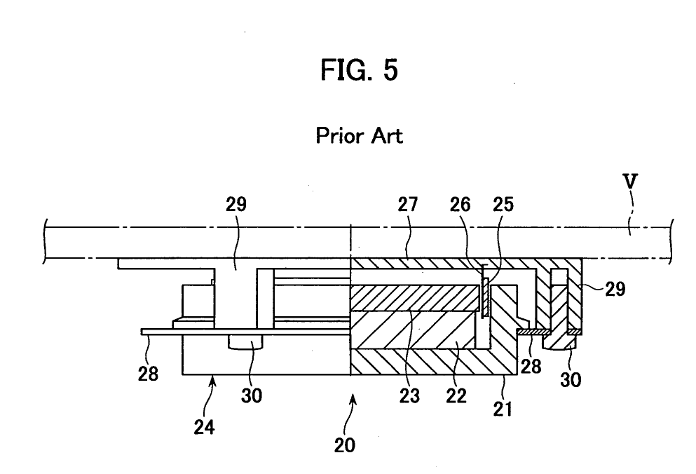

FIGS. 1 to 4 show an electro-dynamic exciter according to a first embodiment of the present invention.

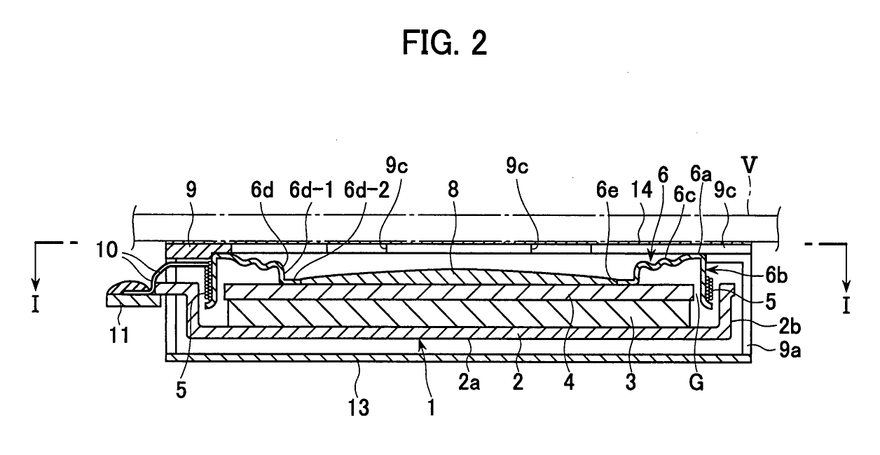

As shown, the electro-dynamic exciter includes a magnetic circuit assembly 1, as in the conventional electro-dynamic exciter. The magnetic circuit assembly 1 includes an outer yoke 2 comprised of a rectangular bottom wall 2a and a cylindrical peripheral wall 2b extending (upwardly as seen in FIG. 2) from the outer peripheral edge of the bottom wall 2a, a flat magnet 3 located within the outer yoke 2 and placed on the bottom wall 2a, and an inner yoke 4 placed on the magnet 3. A magnetic gap G is defined between the peripheral wall 2b of the outer yoke 2 and the outer peripheral surface of the inner yoke 4. A magnetic coil 5 is coaxially located within the magnetic gap G.

The magnetic circuit assembly 1 is vibrationally supported on a support panel 9 by means of a flexible carrier 6. The flexible carrier 6 is in the form of a flexible sheet made, for example, of metal and the like. The flexible carrier 6 includes an annular anchor section 6a fixedly connected to the support panel 9, a cylindrical section 6b coaxially extending into the magnetic gap from the annular anchor section 6a, a flexible section 6c extending radially inwardly from the annular anchor section 6a toward the inner yoke 4, and a joint section 6d secured to the inner yoke 4.

A magnetic coil 5 is wound on the outer peripheral surface of the cylindrical section 6b of the flexible carrier 6. In the embodiment shown in FIG. 4, the flexible carrier 6 is fitted over a bobbin 7. A coil wire is wound on the flexible carrier 6 so as to form the magnetic coil 5. The open end of the cylindrical section 6b of the flexible carrier 6 is slightly bent in a radially outward direction so as to hold the magnetic coil 5 against axial displacement.

As an alternative to the illustrated embodiment, a coil may be formed without a core, and then, the coreless coil may be fitted around the cylindrical section 6b.

As is clear from FIGS. 1 to 3, the flexible section 6c of the flexible carrier 6 is in the form of a generally rectangular ring. The joint section 6d has a cylindrical portion 6d-1 extending from the inner peripheral edge of the flexible section 6c toward the inner yoke, and an adhering portion 6d-2 extending radially inwardly from the cylindrical portion 6d-1. The adhering portion 6d-2 is contacted with the surface of the inner yoke 4 when the magnetic coil 5 is positioned within the magnetic gap as shown in FIG. 1.

A rectangular through opening 6e extends through the adhering portion 6d-2. An adhesive 8 is applied between the adhering portion 6d-2 and the inner yoke 4 via the through opening 6e. In the illustrated embodiment, the adhesive 8 completely fills the opening 6e and convexly projects above the opening 6e. This arrangement increases the adhesive strength between the flexible carrier and the inner yoke, provides improved resistance to vibration and impact, and insures stable acoustic characteristics.

The ends of the magnetic coil wire are electrically connected to terminal circuit pattern 11a by means of lead wires 10. The terminal circuit pattern 11a is formed on a substrate which is, in turn, secured to the outer yoke 2. The ends of the magnetic coil wire are soldered to the lead wires 10. The support panel 9 is provided at its bottom with a cylindrical member 9a. The cylindrical member 9a surrounds the magnetic circuit assembly 1 and has an open end. A dust proof mesh 13 is attached to the open end of the cylindrical member 9a.

A double-sided adhesive tape 14 is used to secure the support panel 9 to a panel V such as an acrylic or vibratory plate attached to the surface of a liquid crystal display used, for example, in a cell phone and other electronic devices. In the illustrated embodiment, the support panel 9 is formed with five vent recesses 9c through which the space between the panel V, the support panel and the flexible carrier 6 can be communicated with ambient atmosphere while the electro-dynamic exciter is vibrated.

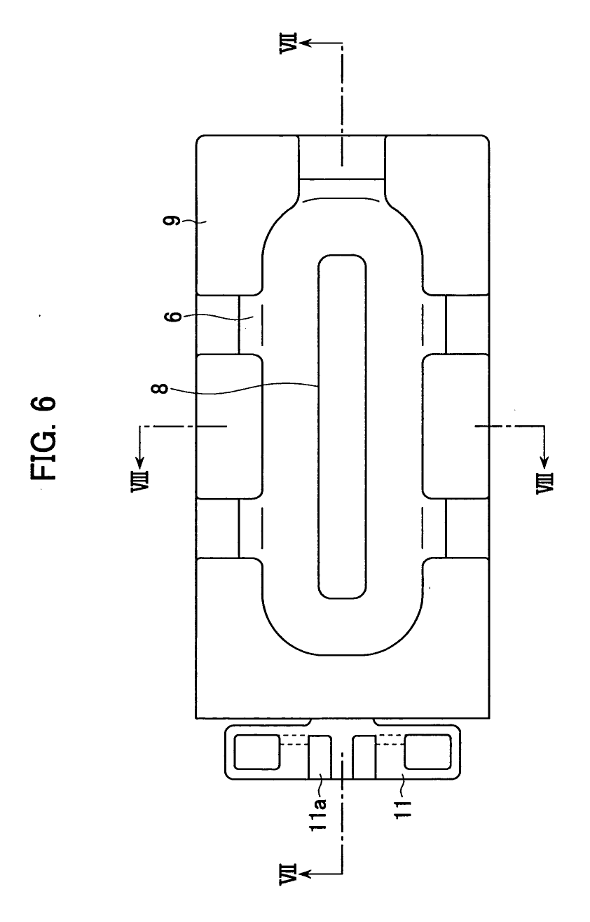

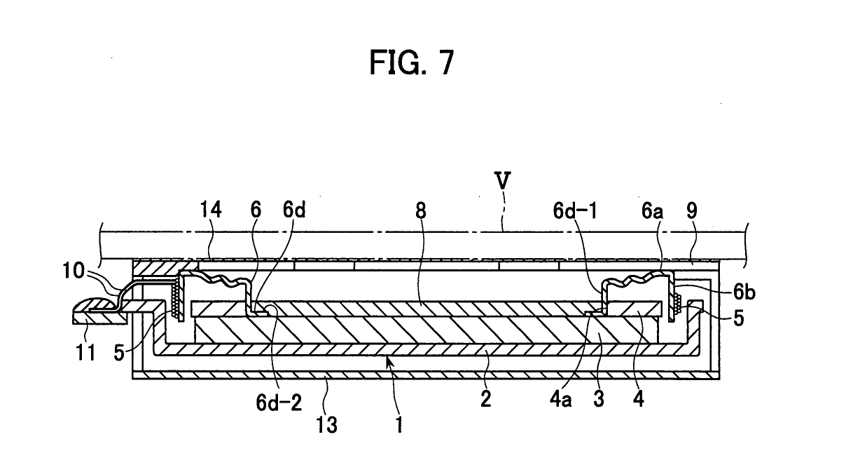

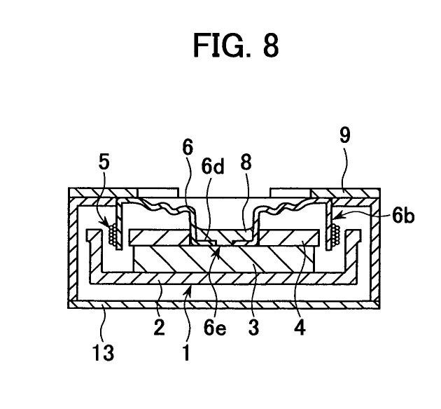

FIGS. 6 to 8 show an electro-dynamic exciter according to another embodiment of the present invention.

This embodiment is substantially similar in structure to the previous embodiment. Like elements are given like reference numerals and will not be described herein (also, in the other embodiments).

The magnetic circuit assembly 1 is composed of the outer yoke 2 substantially in the form of a bowl, the flat magnet 3 placed on the outer yoke 2, and the inner yoke 4 placed on the magnet 3. A through hole 4a is defined centrally in the inner yoke 4 to receive the cylindrical portion 6d-1 of the joint section 6d of the flexible carrier 6. In the embodiment, the adhering portion 6d-2 of the joint section 6d is placed in contact with the surface of the magnet 3. The adhesive 8 is applied between the adhering portion 6d-2 and the magnet 3 through the opening 6e. The adhesive 8 is caused to flow over the entire surface of the joint section 6d so that the flexible carrier 6 and the magnet 3 are firmly secured together. The through hole 4a serves to not only position the flexible carrier 6, but also contain adhesive 8. This arrangement facilitates assembly of the electro-dynamic exciter, increases the adhesive strength, provides improved resistance to vibration and impact, and insures stable acoustic characteristics.

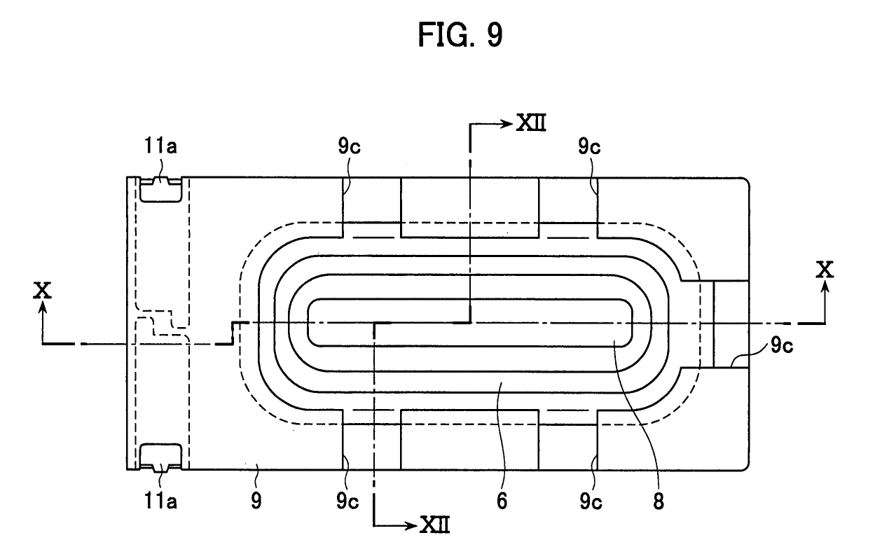

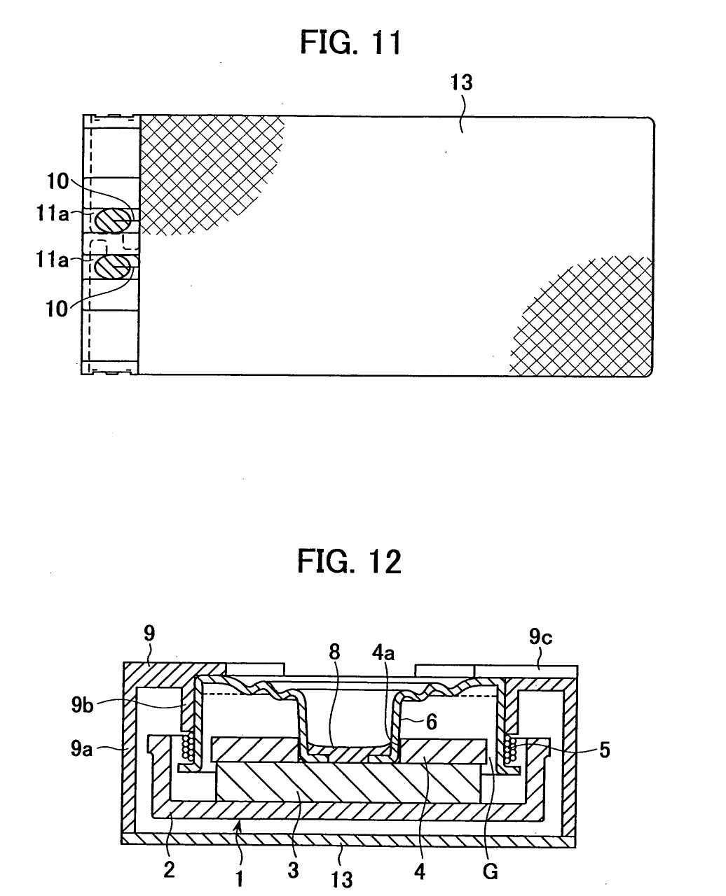

FIGS. 9 to 12 show an electro-dynamic exciter according to an alternative embodiment of the present invention.

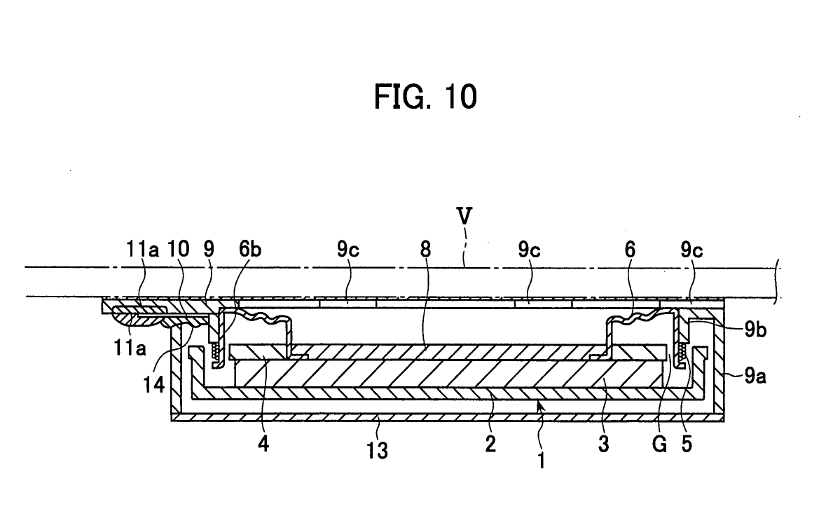

This alternative embodiment is substantially similar in structure to the previous embodiments. Thus, like or similar elements will not be described herein. In this embodiment, the support panel 9 includes another cylindrical member 9b within the cylindrical member 9a. The outer peripheral surface of the cylindrical section 6b of the flexible carrier 6 is secured to the inner peripheral surface of the inner cylindrical member 9b. The support panel 9 has an extension (at the left side of the support panel in FIGS. 9 and 10) which extends outwardly from the outer cylindrical member 9a. The terminal circuit pattern 11a is formed on the panel extension. The lead wires 10, which provide electrical connections between the terminal ends of the magnetic coil 5 and the circuit pattern 11a, are covered by a protective coating 14 made, for example, of resin.

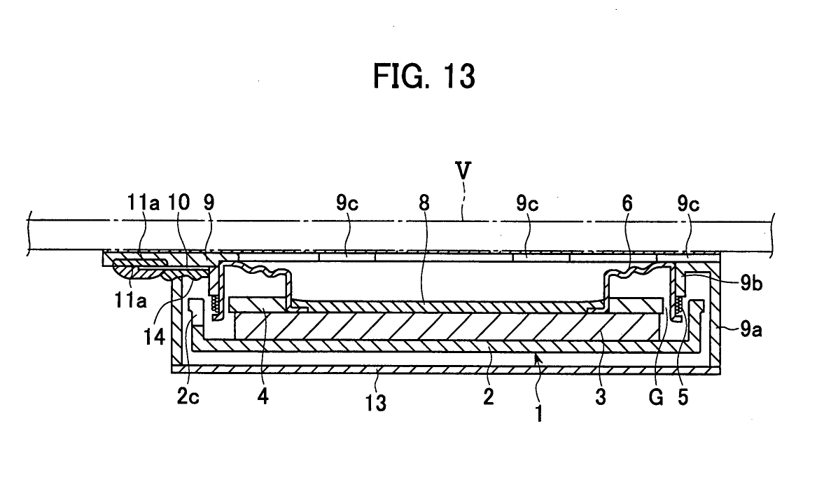

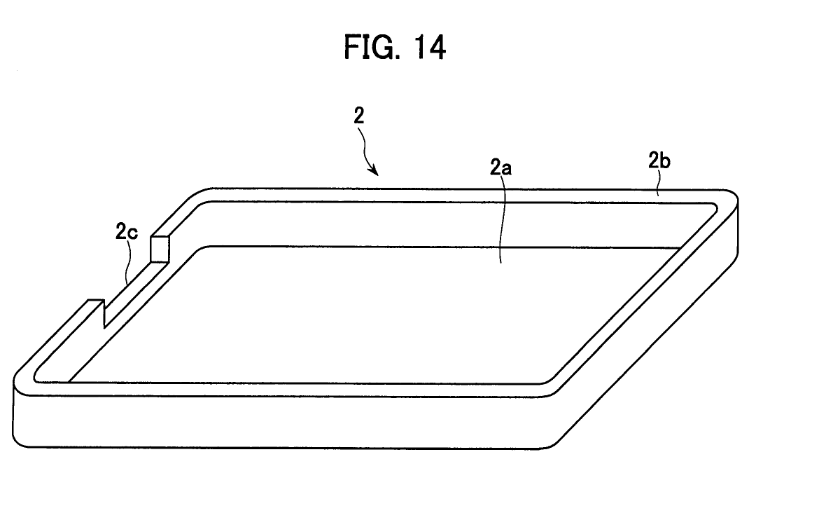

FIGS. 13 and 14 show a modified form of the electro-dynamic exciter. This exciter is substantially similar in structure to that shown in FIGS. 9 to 12, but differs therefrom in that the outer yoke 2 has a cutout 2c. The cutout 2c keeps the outer yoke 2 out of contact with the protective coating 14 during operation of the electro-dynamic exciter. This configuration permits the outer yoke 2 to be located closer to the support panel 9 and also, allows the electro-dynamic exciter to have a low profile.

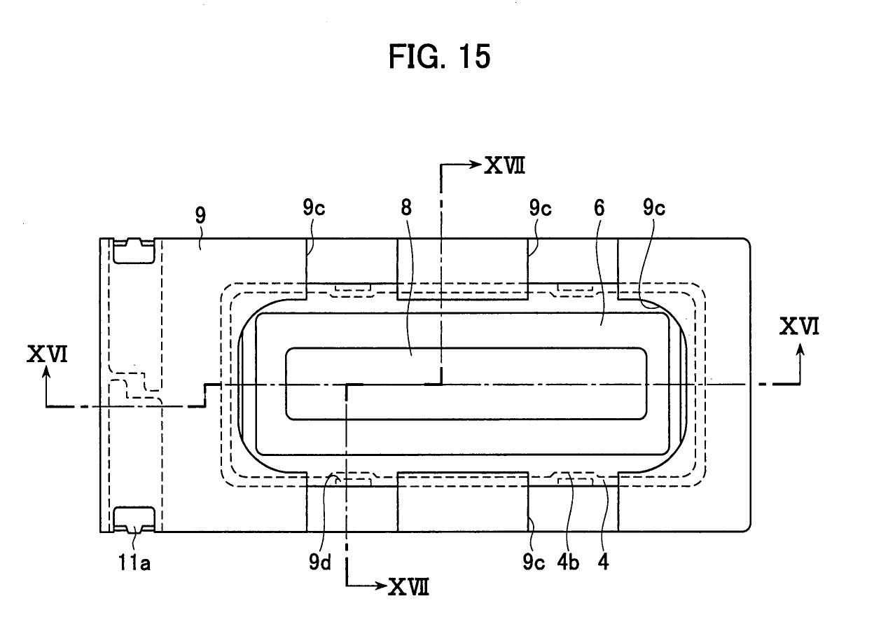

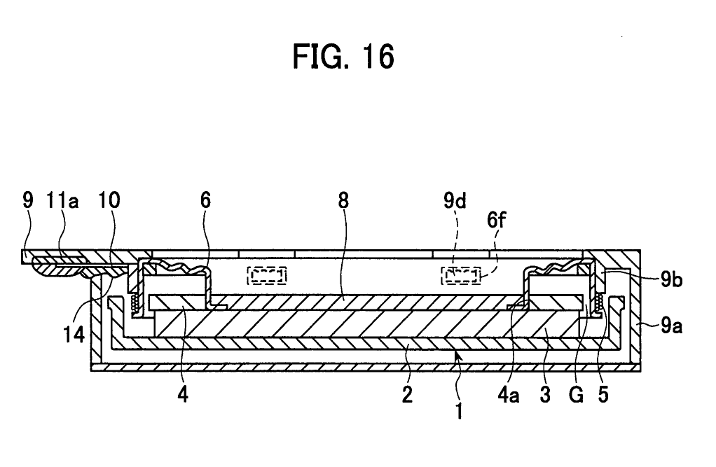

FIGS. 15 to 18 show an electro-dynamic exciter according to a still further embodiment of the present invention.

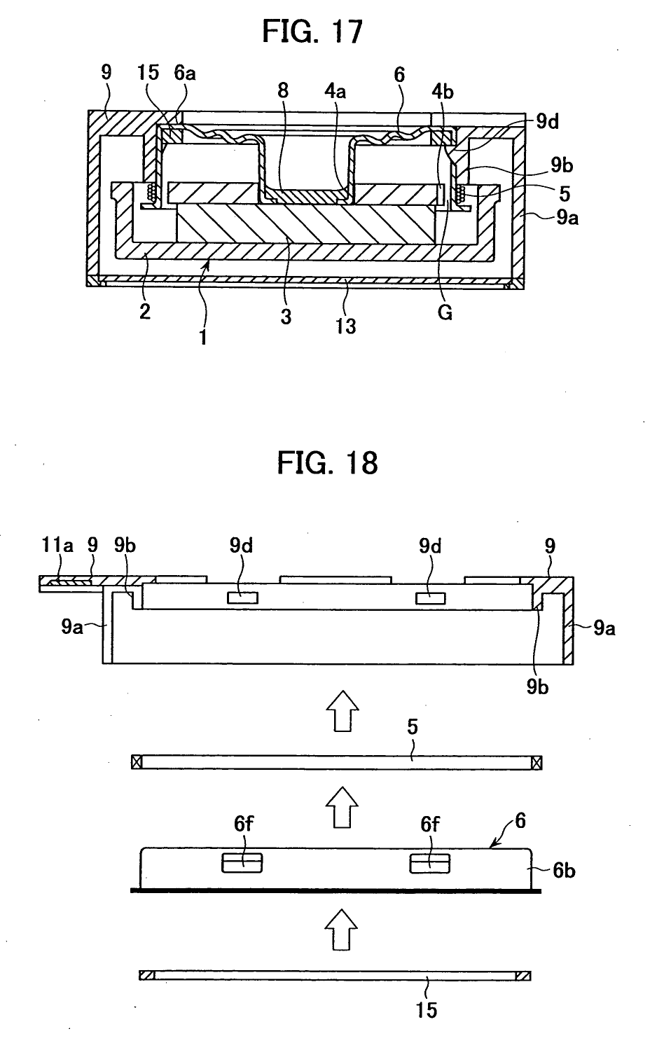

This embodiment is generally similar in structure to the embodiment shown in FIGS. 9 to 12, but is characterized by a means for mounting the flexible carrier 6 to the support panel 9. As shown better in FIGS. 17 and 18, the support panel 9 includes a plurality of locking protrusions 9d extending from the inner peripheral surface of the inner cylindrical member 9b in a circumferentially spaced relationship. A plurality of corresponding apertures 6f are defined in the cylindrical section 6b of the flexible carrier 6 to receive the locking protrusions 9d. In FIG. 18, the reference numeral 15 denotes an elastic ring which has an outer diameter substantially equal to the inner diameter of the cylindrical section 6b of the flexible carrier 6. The flexible carrier 6 is forcibly inserted into the inner cylindrical member 9b of the support panel 9 after the magnetic coil 5 is fitted around the outer peripheral surface of the flexible carrier 6, and the elastic ring 15 is pressed into the flexible carrier 6 from the lower end of the cylindrical section 6b. During this insertion, the elastic ring 15 passes over the locking protrusions 9d, and is then pressed between the annular anchor section 6a of the flexible carrier 6 and the locking protrusions 9d. In this way, the flexible carrier 6 is firmly secured to the support panel 9. An adhesive may optionally be added so as to strengthen the connection between the support panel and the flexible carrier.

In this embodiment, the inner yoke 4 has a cutout 4b as shown in FIGS. 15 and 17. The cutout 4b keeps the inner yoke 4 out of contact with the locking protrusions during operation of the electro-dynamic exciter.

Although the present invention has been described in terms of specific embodiments, it is anticipated that alternations and modifications thereof will no doubt become apparent to those skilled in the art. It is therefore intended that the following claims be interpreted as covering all such alternations and modifications as fall within the true sprit and scope of the invention.

What is claimed is:

1. An electro-dynamic exciter comprising:
a magnetic circuit assembly including an outer yoke having a bottom wall and a cylindrical peripheral wall extending from a peripheral edge of the bottom wall and terminating at a top peripheral edge, a flat magnet placed on the bottom wall of the outer yoke and located within the outer yoke, a flat inner yoke placed on the magnet and having an outer peripheral surface, and an annular magnetic gap defined between the cylindrical peripheral wall of the outer yoke and the outer peripheral surface of the inner yoke;
a support panel mounted in a face-to-face relation to the outer yoke and axially spaced from the top peripheral edge of the outer yoke;
a flexible carrier for supporting the magnetic circuit assembly on the support panel so that the magnetic circuit assembly is axially vibrated, said flexible carrier including an annular anchor section secured to the support panel, a flexible section extending radially inwardly from the anchor section toward one side of the inner yoke located adjacent to the support panel, a joint section extending radially inwardly from the flexible section and joined to the magnetic circuit assembly, and a cylindrical section connected to the anchor section and coaxially extending into the magnetic gap, said cylindrical section having an outer peripheral surface; and
a magnetic coil wound around the outer peripheral surface of the cylindrical section.

2. An electro-dynamic exciter according to claim 1, wherein the joint section of the flexible carrier has at least one through opening, said at least one through opening axially extending through the joint section and adapted to receive an adhesive.

3. An electro-dynamic exciter according to claim 2, wherein the flexible section is annular in shape and has an inner peripheral edge, and
the joint section has a cylindrical portion axially extending from the inner peripheral edge of the flexible section toward the inner yoke and having a distal edge located adjacent to the inner yoke, and an adhering portion extending radially inwardly from the distal edge of the cylindrical portion and adhesively attached to the inner yoke, said at least one through opening being located in said adhering portion.

4. An electro-dynamic exciter according to claim 1, wherein the flexible section is annular in shape and has an inner peripheral edge,
the joint section has a cylindrical portion axially extending from the inner peripheral edge of the flexible section toward the inner yoke and having a distal edge located adjacent to the inner yoke, an adhering portion extending radially inwardly from the distal edge of the cylindrical portion and adhesively attached to the inner yoke, and at least one through opening axially extending through the adhering portion, and
the inner yoke has in said one side a recess sized to receive the adhering portion so that the adhering portion is adhered to the inner yoke.

5. An electro-dynamic exciter according to claim 1, wherein the flexible section is annular in shape and has an inner peripheral edge,
the joint section has a cylindrical portion axially extending from the inner peripheral edge of the flexible section toward the inner yoke and having a distal edge located adjacent to the inner yoke, an adhering portion extending radially inwardly from the distal edge of the cylindrical portion and adhesively attached to the inner yoke, and at least one through opening axially extending through the adhering portion, and
the inner yoke has a through hole axially extending therethrough and sized to receive the joint section so that the joint section is adhered to the magnet.

6. An electro-dynamic exciter according to claim 1, wherein the support panel has a retainer coaxial with the magnetic gap and extending toward the magnetic circuit assembly,
the cylindrical section of the flexible carrier has an outer peripheral surface, and the retainer has an inner peripheral surface connected to the outer peripheral surface of the cylindrical section of the flexible carrier, and
the retainer has a lower end, and the magnetic coil is located downwardly from the lower end of the retainer and wound around the outer peripheral surface of the cylindrical section of the flexible carrier, said magnetic coil being positioned in said magnetic gap.

7. An electro-dynamic exciter according to claim 6, wherein the retainer of the support panel has a cylindrical shape.

8. An electro-dynamic exciter according to claim 6, further comprising a terminal wiring pattern located outwardly of the retainer of the support panel and the peripheral wall of the outer yoke, and
the magnetic coil has a coil wire with terminal ends electrically connected to the terminal wiring pattern.

9. An electro-dynamic exciter according to claim 8, wherein the coil wire has terminal parts extending from the magnetic coil to the terminal wiring pattern along the support panel, said terminal parts of the coil wire being covered by a resinous protective coating.

10. An electro-dynamic exciter according to claim 9, wherein the peripheral wall of the outer yoke has a cutout axially aligned with the protective coating so that the protective coating is kept out of contact with the peripheral wall of the outer yoke.

11. An electro-dynamic exciter according to claim 10, wherein the support panel includes a plurality of locking protrusions projecting from the inner peripheral surface of the retainer,
the flexible carrier includes a plurality of corresponding apertures defined in the outer peripheral surface of the cylindrical section, said plurality of locking protrusions being lockingly engaged with said plurality of apertures so that the flexible carrier is secured to the support panel.

12. An electro-dynamic exciter according to claim 1, wherein the cylindrical section of the flexible carrier has an end radially outwardly bent to hold the magnetic coil against axial displacement.

13. An electro-dynamic exciter according to claim 1, wherein the annular anchor section, the flexible section, the joint section and the cylindrical section of the flexible carrier are integrally formed from a flexible sheet material.
